(19) United States
(12) Patent Application Publication
(10) Pub. No.: US 2002/0156839 A1
(43) Pub. Date: Oct. 24, 2002

(54) System for providing localized content information via wireless personal communication devices

(76) Inventors: Scott Peterson, Houston, TX (US); Hassan Kassir, Ievine, CA (US)

Correspondence Address: Hassan Kassir, 2 Cypress Tree Lane, Irvine, CA, 92612, US

(21) Appl. No.: 10/044,072

(22) Filed: Oct. 26, 2001

Related U.S. Application Data
(60) Provisional application No. 60/243,776, filed on Oct. 26, 2000.

(51) Int. Cl. G06F 15/16; G06F 17/00; G06F 7/00; G06F 17/60

(52) U.S. Cl. 709/203; 707/104.1; 705/26

(57) ABSTRACT

This invention is a software solution for a scalable deployment of geo-localized content on multiple platforms (interactive TV, Internet, wireless, mobile, telematics, PDA, etc.) and devices. The invention allows for the deployment of innumerable localized and content-targeted channels/portals/information systems based on user specifications and parameters. (This is a new art). The specifications and parameters could include (but not be limited to) the following: (1) type of content desired, (2) geographic description based on geo codes, community, zip codes, city, county, MSA—Metropolitan Statistical Area, state, nation, or world, (3) platform specific instructions, (4) device specific instructions, (5) Stylesheet specific instructions, and (6) design specific instructions.

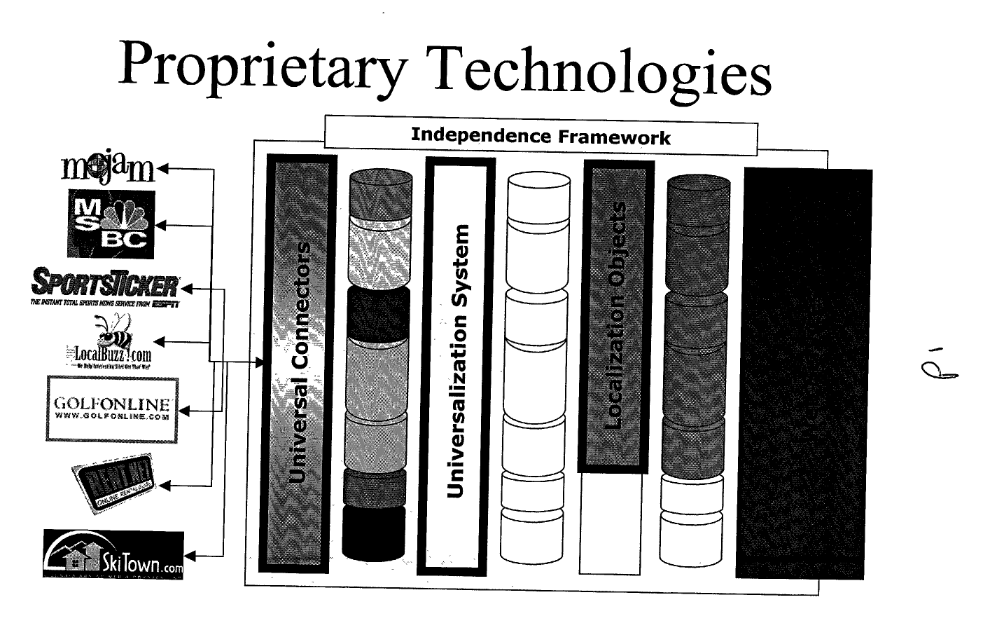

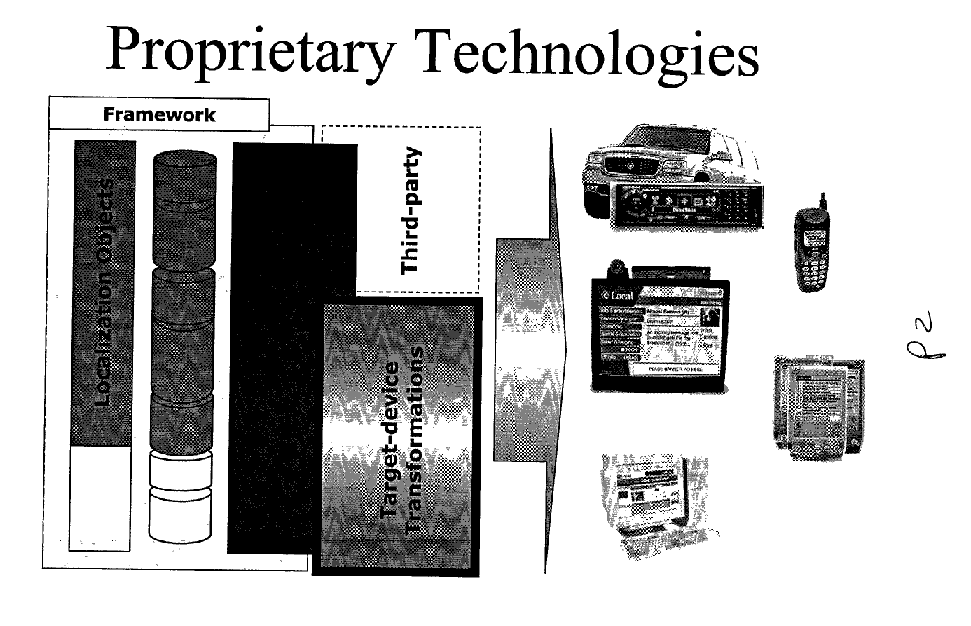

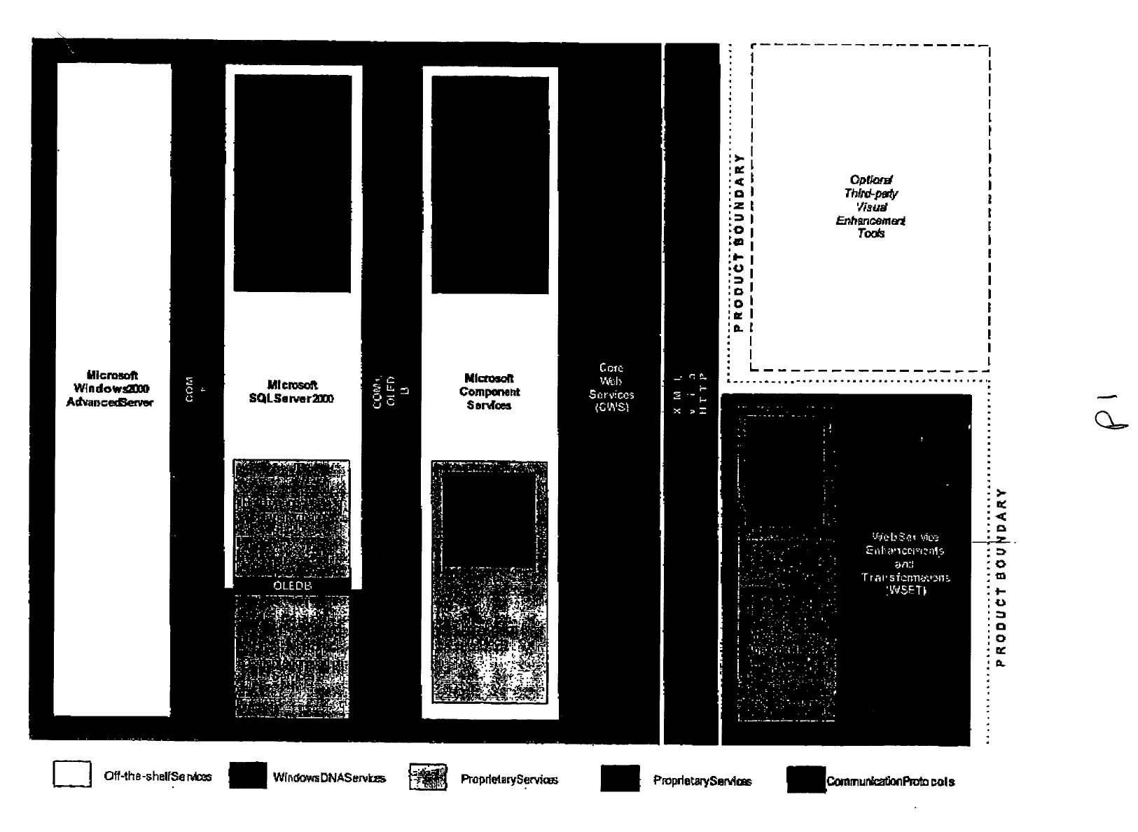

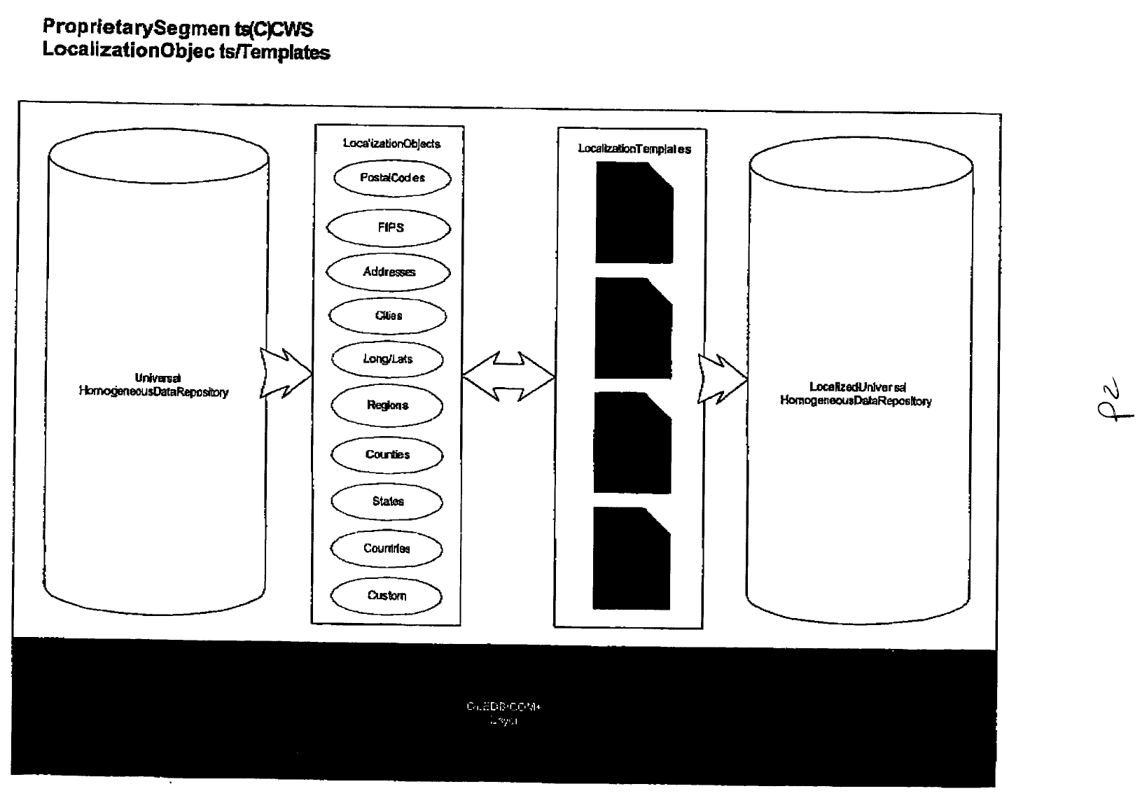

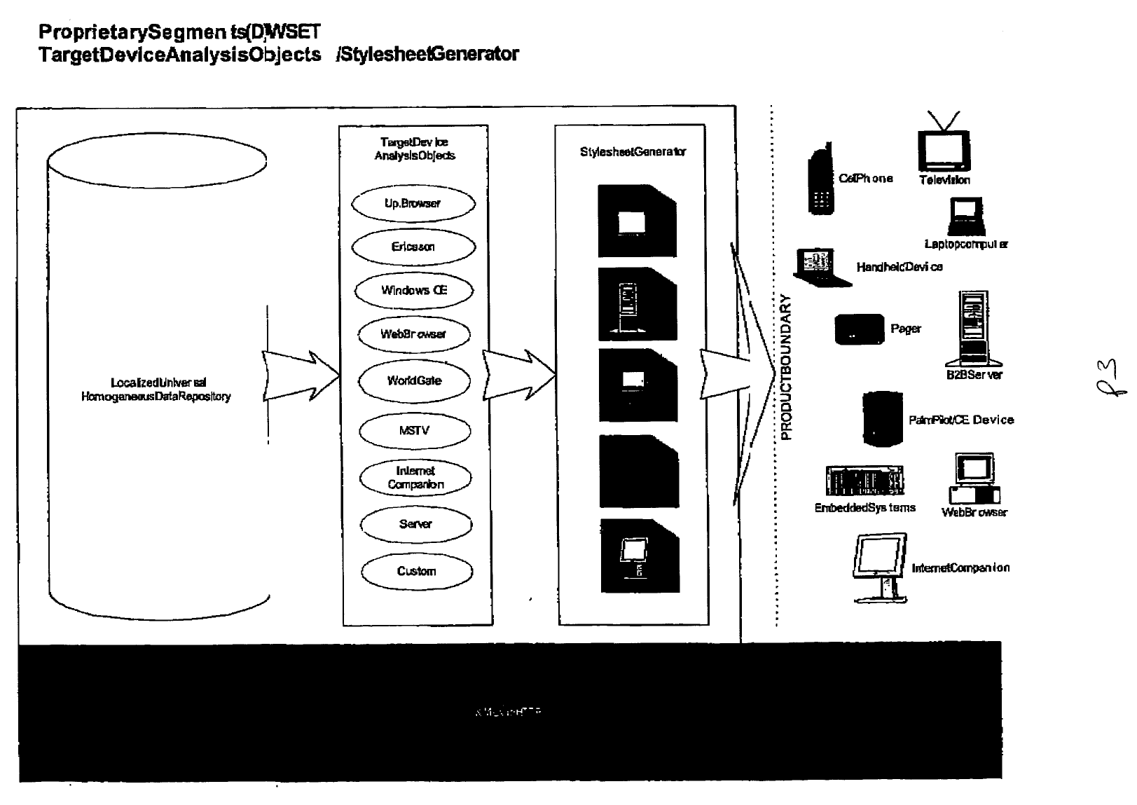

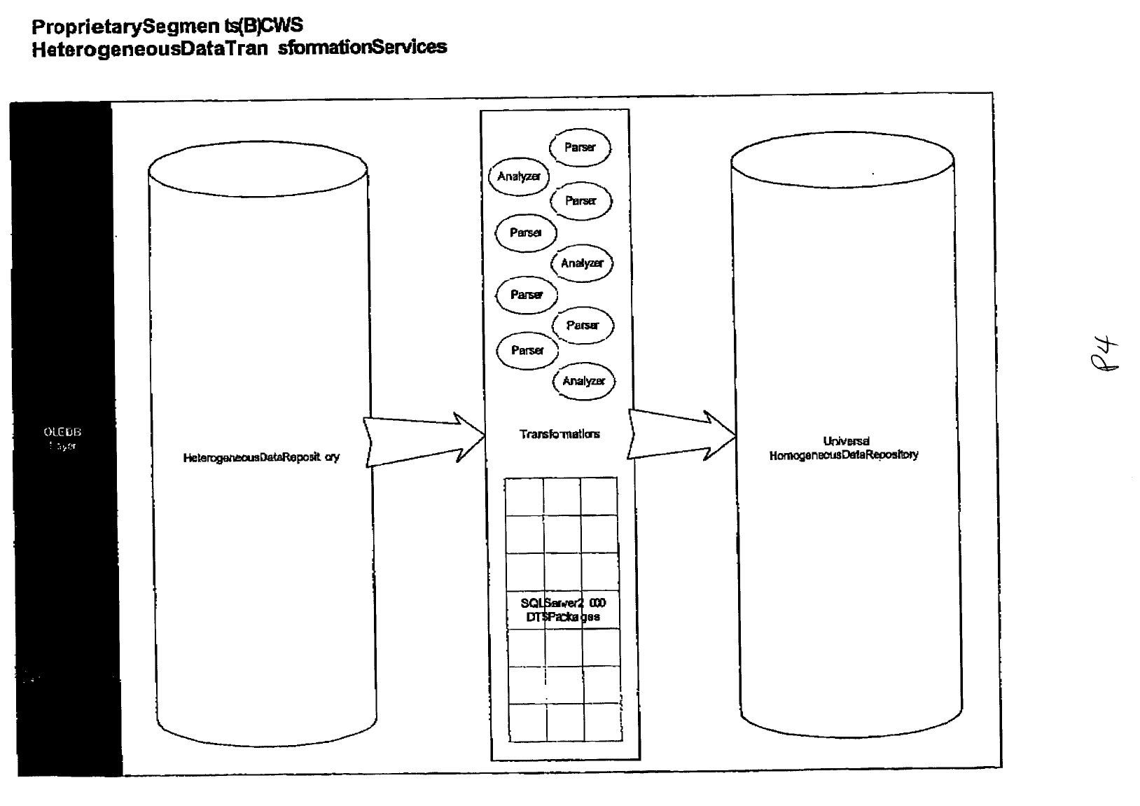

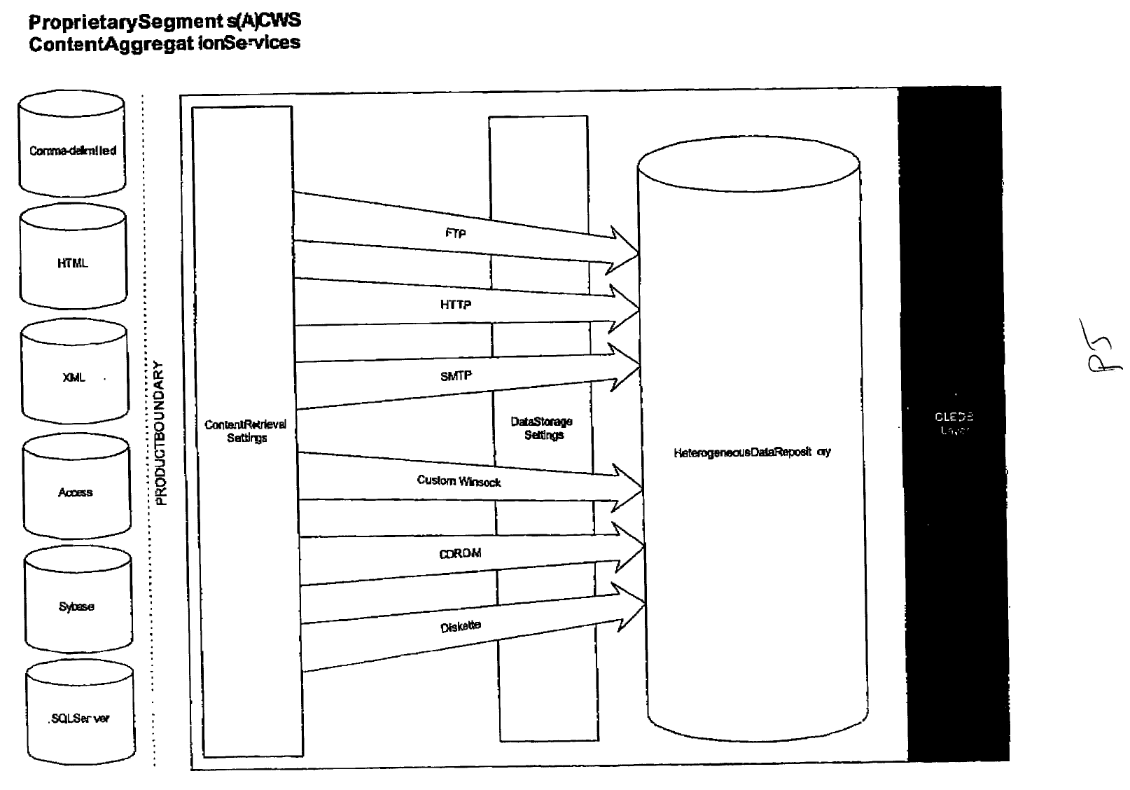

As the provisional patent described, this invention is not limited to wireless. Therefore, we would like to remove the word “Wireless” from the title to make it “System for Providing Localized Content Information Via Personal Communication Devices”

### BACKGROUND OF THE INVENTION

Field of Invention

Software/hardware/computers/network based “technology infrastructure” solution for local media/information/content deployment.

Traditional local media providers (i.e. newspapers, radio stations, local TV stations, yellow pages, etc.) deployments are built, produced, and deployed on market specific station/office infrastructure (a field or station office in every market covered with local staff). Traditional local media provider infrastructure is built one market at a time. Some new media companies (i.e. Digital Cities, City Search, etc.) have used the same traditional local media infrastructure for new media deployment (i.e. Internet, etc.). Traditional local media providers' infrastructure is inefficient, non-scalable, and costly to deploy in multiple markets.

This invention, a “System for Providing Localized Content Information Via Wireless Personal Communication Devices”, introduces a technology based (software/hardware/computers/network driven) scalable deployment (“technology infrastructure”) solution of localized media/content to local media users, providers, merchants, etc. The invention provides aggregated, localized, content targeted, enhanced, integrated, and synthesized media/content to innumerable local markets/communities/channels/portals/information systems/deployments at nationally or internationally defined geographic standards (longitude/latitude, radius from location, user defined irregularly shaped neighborhood/s, community, zip code, postal code, city, province, county, MSA—Metropolitan Statistical Area, state, region, nation, country, or world based), content specific customization, personalization, and market/community size specifications. This system is device, language, and country agnostic. It delivers this solution to multiple platforms (iTV—interactive TV, Internet, wireless, mobile, PDA, telematics) or any device.

This invention creates value by producing: (1) Efficient digital media/content deployment of innumerable and customizable local-2-local (local consumer to local media provider or merchant) channel/portal/information system deployments for multiple platforms, (2) efficient (depth and breadth—super content) media and information to users/consumers, (3) efficient and segmented targeting for media providers, advertisers, users, and merchants, (4) cross platform personalization of media and information (efficient multiple platform connectivity by same user to same information-anytime, anyplace, any device connectivity), (5) efficient cross platform communication (i.e. audiovisual chat from an interactive TV user to wireless/mobile device user), (6) efficient integration of add-on applications, tools, components, and webservices for personalization (agent applications), customization, electronic commerce, online transactions, communication (email, chat, and etc.).

### BRIEF SUMMARY OF THE INVENTION

This invention is a software/hardware/computers/network engine that (1) aggregates content databases with heterogeneous format, (2) stores and manages the data on a network of one or more computers (servers), (3) transforms and enhances the data into a universally accepted/adopted homogeneous format/standard (i.e. XML), (4) combines, stores, and manages transformed homogeneous data into a large virtual database on a network of one or more computers, (5) localizes the data by appending geographic coding (longitude/latitude, community, zip code, postal code, city, province, county, MSA—Metropolitan Statistical Area, state, region, nation, country, or world based), (6) Integrates and synthesizes localized and content targeted data based on a user request specifications for a specific device, and (7) generates a style sheet that exposes the appropriate data to the appropriate device with the appropriate design.

This invention provides enhanced local information for more than 31,000 communities nationwide. The invention aggregates national databases, indexes them geographically, and delivers the information to multiple platforms including cable, wireless, and the Internet.

This invention is not a destination Web site. The invention is a local information engine licensed to cable television, mobile wireless, and Internet Website companies.

### BRIEF DESCRIPTION OF THE SEVERAL VIEWS OF THE DRAWING

There are 2 sets of drawings attached to this application.

The first set of drawing is made-up of 2 pages and is titled “Proprietary Technologies”. It shows a drawing of the entire system identifying the components that built with this invention's proprietary technologies.

1. Universal Connectors: Content Aggregation Services

2. Universalization System: Heterogeneous Data Transformation Services

3. Localization Objects: Localization Objects/Templates

4. Target-Device Transformation: Target Device Analysis Objects/Stylesheet Generator.

The second set of drawings is made-up of 5 pages. It is a copy of original drawing documents submitted with the provisional application referenced above. Here is an explanation of the five pages:

1. Proprietary Segments (Breakdown)/Page One: This is an Overall Invention System Description Showing the Main Proprietary Technology components.

2. Proprietary Segments (A)/Page Two: Content Aggregation Services

Content Aggregation services are a collection of proprietary libraries and applications developed for the Microsoft Windows 2000 operating system that actively communicate with the remote services of authorized data providers to gather updated information in a wide variety of data storage formats.

3. Proprietary Segments (B)/Page Three: Heterogeneous Data Transformations Services

Heterogeneous Data Transformations Services leverage the Microsoft SQL Server 2000 Data Transformation Services (DTS) as a collection of “packages” that update the various clusters of Microsoft SQL Server 2000 datastores in real-time based on data transferred via the Content Aggregation Services. These DTS packages “wrap around” and “activate” proprietary business objects that contain transformation logic beyond the capabilities of DTS, such as accessing remote registries and transferring data via File Transfer Protocol (FTP).

4. Proprietary Segments (C)/Page Four: Localization Objects

Localization Objects are a collection of proprietary libraries, housed in Microsoft COM+Applications, that leverage a set of proprietary Localization Templates to generate geography-specific data enhancements, such as postal codes, longitudes and latitudes, Federal Information Processing Standards (FIPS) codes, etc. The Localization Objects also determine, via the Localization Templates, how a given web service is exposed to a partner for reuse.

Proprietary Segments (C): Localization Templates

Localization Templates are an optional collection of proprietary libraries and applications that interrogate and identify a requesting (target) device to determine the specific limitations and native support of the target in order to reply with an appropriate, properly formatted response, such as sending Hypertext Markup Language (HTML) data to a web browser, or Wireless Markup Language (WML) data to a cell phone.

5. Proprietary Segments (D)/Page Five: Target Device Analysis Objects

Target Device Analysis Objects are an optional collection of proprietary libraries and applications and interrogate and identify a requesting (target) device to determine the specific limitations and native support of the target in order to reply with an appropriate properly formatted response, such as sending Hypertext Markup Language (HTML) data to a web browser, or Wireless Markup Language (WML) data to a cell phone.

Proprietary Segments (D): Stylesheet Generator

The Stylesheet Generator is an optional application that works in tandem with the Target device Analysis Objects to build the visual enhancement needed to show the contents of a web service on a given device. The Stylesheet Generator can also be managed by a human resource to further manipulate the physical “look and feel” or design that a target device would display.

### DETAILED DESCRIPTION OF THE INVENTION

This invention is a software/hardware/computers/network system comprising: A “technology infrastructure” network based software/hardware system deployment solution that is comprised of one or more computers/servers (hardware), one or more operating systems (software), one or more applications/servers (software), and proprietary software components that allow for deployment of innumerable scalable localized and content targeted channels/portals/information systems to multiple platforms (interactive TV, Internet, wireless, mobile, PDA, telematics, etc.) and devices based on user/provider specifications. A user requesting localized and targeted content to be deliverd to a specific platform or device with clear instructions defining the geographic, content, platform, device, stylesheet, and design specifications initiates a request/query/inquiry that interrogates the system (invention). The system responds with a data stream that provides the localized and targeted content data to the requesting device.

The invention provides enhanced local information for more than 31,000 communities nationwide. The invention aggregates national databases, indexes them geographically, and delivers the information to multiple platforms including cable, wireless, and the Internet.

The invention is not a destination Web site. The invention is a local information engine licensed to cable television, mobile wireless, and Internet Website companies.

Research conducted by Jupiter Communications indicates that average Americans spend 80% of their time and disposable income on products and services within a 25-mile radius of their homes. Traditionally, local information and advertising have been distributed through local television, newspapers, magazines, and yellow page directories. For decades, these companies have dominated this $214 billion local advertising market by providing effective ways for local buyers and sellers to find each other. New breakthroughs in information technology have created a window of opportunity to new players to enter this arena.

Currently, there are three industries poised to capture this market by delivering this information electronically:

Cable

Interactive digital television will ultimately reach over 70 million households and the cable industry is poised to capture the lion's share of the local advertising market. To date, every prototype of the next generation of interactive television (iTV) includes a “LOCAL” button clearly situated on the opening page. With first and second generation digital set-top boxes in full production and distribution, the search for a scalable, local, interactive information source has intensified with all major cable operators actively seeking local content and technology partners that can meet their needs.

Wireless Devices

Ovum research has predicted that in 2000, over 72 million wireless devices will be shipped in the US. Local information and services continue to rank as the most requested category among users of wireless devices. Wireless providers are scrambling to aggregate relevant local content, but are discovering that databases with relevant local information are not standardized. It is also difficult to find applications that can be easily accessed by these limited devices.

Internet Portals

According to recent research conducted by Cyber Dialogue, local information now ranks as the sixth most accessed category among end users of the World Wide Web. The Kelsey group has proven that Internet companies choosing to integrate local and localization features are boosting their traffic and user loyalty by 30%. The demand for seamless integration of local information and services has never been stronger.

Proprietary Segments (Breakdown)

Proprietary Segments (A): Content Aggregation Services

Content Aggregation services are a collection of proprietary libraries and applications developed for the Microsoft Windows 2000 operating system that actively communicate with the remote services of authorized data providers to gather updated information in a wide variety of data storage formats.

Proprietary Segments (B): Heterogeneous Data Transformations Services

Heterogeneous Data Transformations Services leverage the Microsoft SQL Server 2000 Data Transformation Services (DTS) as a collection of “packages” that update the various clusters of Microsoft SQL Server 2000 datastores in real-time based on data transferred via the Content Aggregation Services. These DTS packages “wrap around” and “activate” proprietary business objects that contain transformation logic beyond the capabilities of DTS, such as accessing remote registries and transferring data via File Transfer Protocol (FTP).

Proprietary Segments (C): Localization Objects

Localization Objects are a collection of proprietary libraries, housed in Microsoft COM+ Applications, that leverage a set of proprietary Localization Templates to generate geography-specific data enhancements, such as postal codes, longitudes and latitudes, Federal Information

Processing Standards (FIPS) codes, etc. The Localization Objects also determine, via the

Localization Templates, how a given web service is exposed to a partner for reuse.

Proprietary Segments (C): Localization Templates

Localization Templates are an optional collection of proprietary libraries and applications that interrogate and identify a requesting (target) device to determine the specific limitations and native support of the target in order to reply with an appropriate, properly formatted response, such as sending Hypertext Markup Language (HTML) data to a web browser, or Wireless Markup Language (WML) data to a cell phone.

Proprietary Segments (D): Target Device Analysis Objects

Target Device Analysis Objects are an optional collection of proprietary libraries and applications and interrogate and identify a requesting (target) device to determine the specific limitations and native support of the target in order to reply with an appropriate properly formatted response, such as sending Hypertext Markup Language (HTML) data to a web browser, or Wireless Markup Language (WML) data to a cell phone.

Proprietary Segments (D): Stylesheet Generator

The Stylesheet Generator is an optional application that works in tandem with the Target device Analysis Objects to build the visual enhancement needed to show the contents of a web service on a given device. The Stylesheet Generator can also be managed by a human resource to further manipulate the physical “look and feel” or design that a target device would display.

1. A “System for Providing Localized Content Information Via Wireless Personal Communication Devices” comprising: A “technology infrastructure” software/hardware/computers/network system deployment that is comprised of one or more computers/servers (hardware), one or more operating systems (software), one or more applications/servers (software), and proprietary software components that allow for deployment of scalable localized and content targeted channels/portals/information systems to multiple platforms (interactive TV, Internet, wireless, mobile, PDA, telematics, etc.) and devices based on user request specifications,

2. A system that aggregates the aggregators of content (heterogeneous databases) from innumerable sources,

3. A system that stores and manages innumerable heterogeneous databases on network computer/s (servers) and makes them ready and available for data manipulation and enhancement,

4. A system that universalizes data (makes it heterogeneous—uses universally recognized/accepted/adopted formats/standards, i.e. XML) making it readily available for integration with other data as well as delivery to users in a universally defined and acceptable standard/format.

5. A system that enhances and localizes data by method of appending geographic coding to each record thus allowing the geographic definition of data by nationally and internationally well established standards such as longitude/latitude, community, zip code, postal code, city, province, county, MSA—Metropolitan Statistical Area, state, region, nation, country, world, or etc.,

6. A system that integrates and synthesizes data/media/information based on user specifications/inquiry/request/search thus creating content that is enhanced in breadth and depth (creating super content by combining complimentary content),

7. A system that exposes the data via web services and independent applications to multiple platforms (interactive TV, Internet, wireless, mobile, PDA, telematics, etc.) and devices based on user specifications, instructions and design,

8. A system that generates stylesheets to user device based on user instructions,

9. A system that adds transactional components and applications, and agents for online commerce,

10. A system that allows users to deploy innumerable local channels/portals/information systems based on user's geographic, content, platform, device, stylesheet, and design specifications.

11. A system that allows users to deliver targeted advertising based on the localized specifications mentioned above (10.),

12. A system that allows users to deliver transactional services based on the localized specifications mentioned above (10.),

13. A system that allows for personalization of browsers and customization of interface/device,

14. A system that combines and integrates with other utilities and applications (chat, email, productivity tools, personal utility applications, etc.) to deliver a comprehensive localized information systems solution,

15. A system that allows for cross platform (interactive TV, wireless, mobile, PDA, Internet, telematics, or etc.) communication.
